(19) United States
(12) Patent Application Publication
(10) Pub. No.: US 2007/0123254 A1
(43) Pub. Date: May 31, 2007

(54) Method for improving channel scanning in portable internet system and apparatus using the same

(75) Inventors: Yong-Seouk Choi, Daejeon-city (KR); June-Bae Seo, Daejeon-city (KR); Nam-Hoon Park, Daejeon-city (KR)

Correspondence Address: DILWORTH & BARRESE, LLP, 333 EARLE OVINGTON BLVD., SUITE 702, UNIONDALE, NY, 11553, US

(73) Assignees: SAMSUNG ELECTRONICS CO., LTD., Suwon-si (KR); ELECTRONICS AND TELECOMMUNICATIONS RESEARCH INSTITUTE, Daejeon (KR); KT Corporation, Seongnam-city (KR); SK TELECOM CO., LTD, Seoul (KR); HANARO TELECOM., INC., Seoul (KR)

(21) Appl. No.: 11/598,592

(22) Filed: Nov. 13, 2006

(30) Foreign Application Priority Data
Nov. 11, 2005 (KR) 10-2005-0107959

(51) Int. Cl. H04Q 7/20

(52) U.S. Cl. 455/434

(57) ABSTRACT

A channel scanning apparatus in a portable Internet system establishes a radio link with each of neighboring access points without disconnecting a wireless link with a serving access point and collects radio channel state information of each of the respective neighboring access points. That is, apart from a RF signal processing unit that processes a radio signal from the serving access point, the channel scanning apparatus includes a dedicated scanning processing unit for processing a radio signal of a neighboring access point and measuring radio channel state information of the neighboring access point from the radio signals received by the dedicated scanning processing unit, and collects radio channel state information of the respective neighboring access points. In such a way, communication with the serving access point is not disconnected, and therefore the access terminal and the serving access point do not need to buffer traffic data.

### PRIORITY

This application claims priority under 35 U.S.C. §119 to a Korean application filed in the Korean Intellectual Property office on Nov. 11, 2005 and allocated Serial No. 2005-0107959, the contents of which are incorporated herein by reference.

### BACKGROUND OF THE INVENTION

1. Field of the Invention

The present invention relates to a channel scanning apparatus for collecting a carrier to interference and noise ratio (CINR) that indicates channel state information of a neighboring access point required for a handover and traffic load sharing of a serving access point in a portable Internet system, and a method thereof and more particularly to a method for improving channel scanning in a portable Internet system and an apparatus using the same.

2. Description of the Related Art

Portable Internet is a high-speed communication service, which offers various information and content that a user can access by using a Portable Wireless Access Terminal with 2.4 GHz frequency bandwidth. Unlike the conventional Wireless Local Area Network (WLAN) and the conventional wireless communication-based portable Internet, the portable Internet offers high speed Internet access in a mobile context and is expected to provide a service that takes advantage of the WLAN and the wireless Internet (i.e., high-speed data service and mobility) and overcomes drawbacks of the WLAN and the wireless Internet.

IEEE 802.16e-based portable Internet system supports handover such that an access terminal can be provided with seamless service connectivity even though the access terminal moves from one sector to another sector within the same serving access point (cell), moves to a different access point, or moves to a different bandwidth. In order to control the handover and traffic load sharing of the serving access point, the portable Internet system requires channel state information, that is, carrier to interference and noise ratio (CINR) information of a neighboring access point. The process of collecting the CINR information of the neighboring access point is called a channel scanning process.

FIG. 1 shows a scanning process of a typical portable Internet system.

As shown in FIG. 1, an Access Terminal (AT) periodically monitors CINR information of a current serving access point (AP) and performs a scanning function when the measured CINR is less than a predetermined threshold value. That is, the AT reports the scanning start time to the serving AP through a scanning request message (SCN_REQ) in step S10. When receiving the SCN-REQ, the serving AP allocates a time interval to the AT so that the AT can search for an appropriate neighboring AP and collect information during the time interval, and transmits the timing interval to the AT through a scanning response message (SCN_RSP) in step S20. The time interval is referred to as a scanning interval. When the AT is allocated with the scanning interval from the serving AP through the SCN-RSP, the AT searches for a neighboring AP during the scanning interval allocated by the serving AP and performs synchronization with the searched neighboring AP. After synchronization, the AT measures the channel state of the neighboring AP. The AT measures the CINR of the neighboring AP, in step S30. While the AT is performing the scanning function, the frequency bandwidth of the AT and other wireless parameters that have been used for establishing a radio link with the serving AP are modified for synchronization with the neighboring AP. The radio link with the current serving AP is disconnected. The AT cannot communicate with the current serving AP during the scanning interval, and traffic data to be transmitted to the AT is buffered by the serving AP and traffic data to be transmitted to the serving AP is buffered by the AT during the scanning interval. After finishing the scanning interval, the AT re-establishes a radio link with the serving AP by performing synchronization with the serving AP. When there is traffic data buffered by the AT or the serving AP during the scanning interval, the buffered traffic data are transmitted to the serving AP or the AT.

Since the portable Internet system guarantees mobility within 60 km, such scanning is operated in association with frequent occurrence of a handover operation, and more particularly, channel scanning is more frequently operated when the AT is located within a cell boundary area. In addition, when the AT has a plurality of neighboring APs and is located within a neighboring AP boundary area, the AT needs a longer scanning interval for checking the channel state of each of the neighboring APs. A hardware device of the AT experiences a switching operation when modifying frequency or a wireless parameter for synchronization with a single neighboring AP or another neighboring AP. Therefore, guard intervals may be provided before and after the scanning interval, and accordingly, the actual scanning interval is increased. Since the AT is synchronized with the neighboring AP during the scanning interval, the radio link between the AT and the serving AP is disconnected. The serving AP and the AT must buffer traffic data during the scanning interval, and a user cannot temporarily use services of the serving AP during the scanning interval. A serving AP that manages a plurality of ATs must buffer traffic data for all the ATs, thereby increasing the buffering load.

Korean Publication No. 2005-45223 (entitled “Scanning Power of Neighboring Base Station in the Wideband Wireless Access Communication System”) describes the channel scanning method. According to this prior art, rather than setting a scanning interval for measuring the power of the neighboring access point the power of a neighboring access point is measured during a frame interval where no data among data frames received from a serving access point is allocated to the corresponding access terminal. However, this method cannot be applied to a neighboring AP having a different frequency bandwidth than the frequency bandwidth of the serving AP. That is, this method can be applied to APs having the same frequency bandwidth.

### SUMMARY OF THE INVENTION

The present invention has been made in an effort to provide a channel scanning apparatus having the advantages of performing scanning without disconnecting from a serving access point or without producing any effect on the serving access point in a portable Internet system.

A channel scanning apparatus according to the present invention is provided to an access terminal that collects radio channel state information of a neighboring access point. The channel scanning apparatus includes a dedicated Scanning Processing Unit, a Modem Processing Unit, a Scanning Processing Unit, and a Central Controller. The dedicated scanning processing unit establishes a radio link with the neighboring access point by using neighboring access point information that is required for establishing the radio link. The modem processing unit measures radio channel state information of the neighboring access point from the radio signal received at the dedicated scanning unit. The scanning processing unit stores the neighboring access point information in the dedicated scanning processing unit, the modem process unit, and collects radio channel state information of the neighboring access point, the radio channel state information being measured by the modem processing unit. The central controller controls operation of the scanning processing unit, periodically receives the neighboring access point information, and transmits the neighboring access point information to the scanning processing unit.

Another channel scanning method according to the present invention is provided to collect radio channel state information of a neighboring access point in a portable Internet system. The channel scanning method includes: a) providing neighboring access point information necessary for establishing a radio link with the neighboring access point; b) establishing the radio link with the neighboring access point by using the stored neighboring access point information and receiving a radio signal; c) measuring radio channel state information of the radio signal received from the neighboring access point; and d) repeating a) to c) for a number of neighboring access points and collecting radio channel state information of the neighboring access points.

According to the present invention, radio channel state information can be measured by establishing a radio link between an access terminal and a neighboring access point without disconnecting the radio link established between the access terminal and the serving access point such that the access terminal can communicate with the serving access point without either one having to buffer traffic data.

### BRIEF DESCRIPTION OF DRAWINGS

FIG. 1 shows a scanning process in a typical portable Internet system.

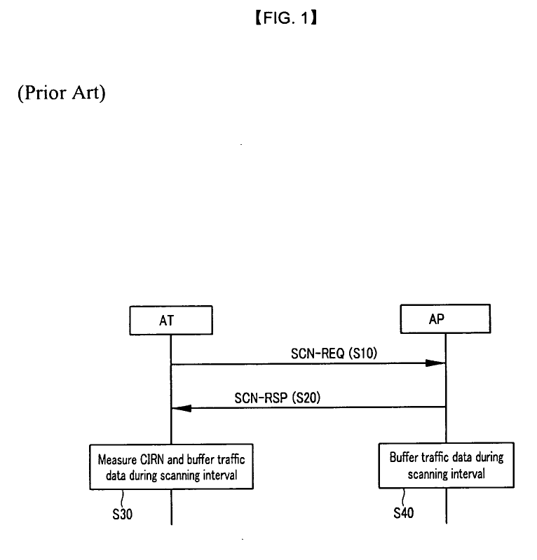

FIG. 2 shows a portable Internet system according to the present invention.

FIG. 3 shows a channel scanning apparatus of the portable Internet system according to the present invention.

FIG. 4 is a flowchart of the channel scanning apparatus of the portable Internet system according to f the present invention.

### DETAILED DESCRIPTION OF THE PREFERRED EMBODIMENTS

A preferred embodiment of the present invention will hereinafter be described in detail with reference to the accompanying drawings.

In the following detailed description, certain preferred embodiments of the present invention have been shown and described by way of illustration. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification and drawings. A channel scanning apparatus and a method thereof will now be described in more detail with reference to the accompanying drawings.

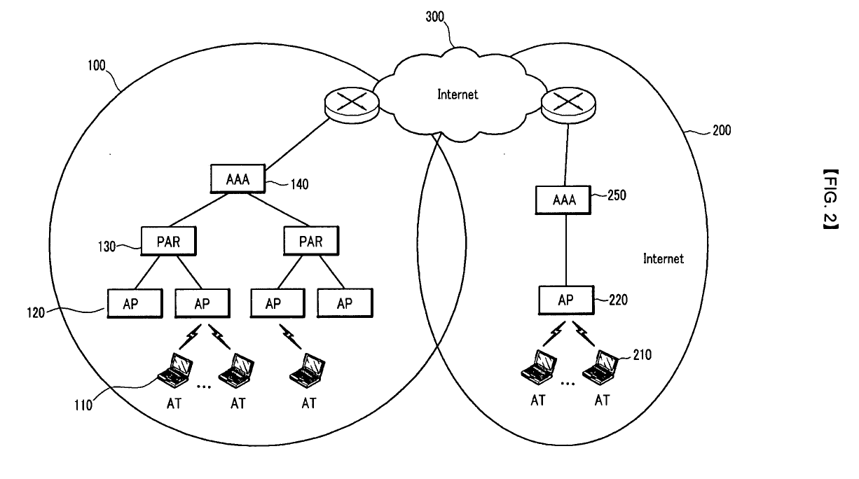

As shown in FIG. 2, the portable Internet system includes an Access Terminal (AT) 110, an Access Point (AP) 120, a Packet Access Router (PAR) 130, and an Authentication, Authorization, and Accounting (AAA) server 140.

AT 110 is used by a user for receiving portable Internet services and has mobility, accesses AP 120 and performs radio channel transmitting/receiving at 2.3 GHz bandwidth frequency based on a standard wireless access protocol so as to transmit/receive high-speed packet data.

AP 120 connects a wireless network and a wired network, and directly provides wireless packet data services to AT 110 from an end node of the wired network through a wireless interface. That is, AP 120 performs initial access, inter-sector handover control, and quality of service (QoS) control, and transmits a radio signal received from AT 110 to PAR 130, or converts various information received from PAR 130 into radio signals and transmits the radio signals to AT 110.

PAR 130 is connected with a plurality of APs 120 through an IP-based wired network and controls AT 110 and AP 120, routes IP packets, and performs an external foreign agent function of a mobile IP. In this case, a single packet access router coverage area forms a single IP subnet. In addition, the external foreign agent function performs registration of a user or release of the registration so as to maintain connectivity of the user moving to another service network when providing packet-based Internet access and roaming service.

AAA server 140 accesses PAR 130 through Internet 300 and performs authorization, authentication, and accounting on the user and AT 110 so as to provide the user with portable Internet access and services. AAA server 150 uses a diameter protocol that has been standardized by the Internet Engineer Task Force (IETF). Such a diameter protocol enables transmission of authorization, authentication, and accounting information by interacting of servers.

With the above configuration, portable Internet system 100 can interact with a different Internet 200 formed of an AT 210, an AP 220, and an AAA server 250, a cellular network, or a wireless local area network, and may include a plurality of PARs 130 in the same network. In addition, a plurality of APs 120 can be provided within a single PAR 130, and a single AP 120 can serve a plurality of ATs. When AT 110 moves from a cell served by AP 120 to another cell, AT 110 can be provided with services from the cell served by AP 120.

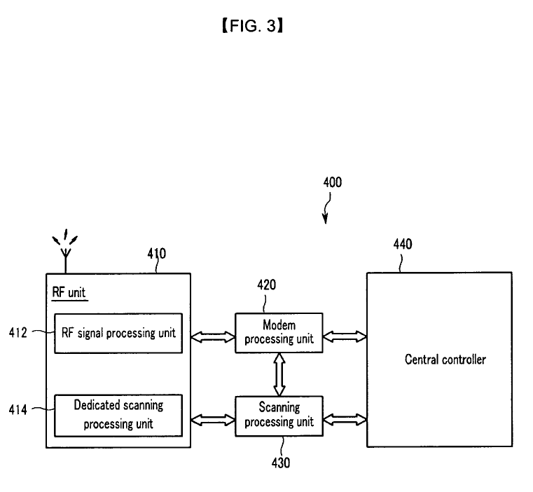

FIG. 3 shows a channel scanning apparatus of the portable Internet system according to the present invention.

As shown in FIG. 3, channel scanning apparatus 400 of the portable Internet system includes a Radio Frequency (RF) Unit 410, a Modem Processing Unit 420, a Scanning Processing Unit 430, and a Central Controller 440.

RF unit 410 includes a RF Signal Processing Unit 412 and a dedicated Scanning Processing Unit 414. RF Signal Processing Unit 412 processes a radio signal transmitted/received through a radio link with a serving AP, and dedicated Scanning Processing Unit 414 transmits a radio signal received from each of neighboring ATs to the modem processing unit 420 so as to collect radio channel state information of the respective neighboring APs, separated from the RF Signal Processing Unit 412. In more detail, dedicated Scanning Processing Unit 414 is independently operated without interrupting RF Signal Processing Unit 412 so as to prevent the radio link with the serving AP from being disconnected. That is, apart from transmitting/receiving the radio signal through the radio link with the serving AP, the dedicated Scanning Processing Unit 414 establishes a radio link with each serving AP by using information of each serving AP, and receives a radio signal transmitted through the radio link and transmits the received radio signal to the Modem Processing Unit 420,

In this case, the neighboring AP information may include a preamble index of the radio signal transmitted from the neighboring AP and frequency bandwidth information of the neighboring AP.

Modem Processing Unit 420 modulates or demodulates a transmitted/received signal. In this case, the Modem Processing Unit measures a CINR that corresponds to radio channel state information from the radio signal of the neighboring AP transmitted from the dedicated Scanning Processing Unit 414, and transmits the CINR to the Scanning Processing Unit 430.

Scanning Processing Unit 430 performs overall functions for scanning processing in accordance with a control of Central Controller 440. In more detail, when a radio link is established between AT 110 and the serving AP, Scanning Processing Unit 430 is changed into a channel scanning operation ready state, receives neighboring AP information that is required when establishing a radio link with each neighboring AP to collect CINRs of each neighboring AP and provides the received neighboring AP information to RF unit 410 and in the modem processing unit and receives neighboring AP information from Modem Processing Unit 420, and collects the measured CINRs of the respective neighboring APs from Modem Processing Unit 420. Scanning Processing Unit 430 compares the collected CINR of each neighboring AP and a CINR of a current serving AP so as to control an interval for measuring a CINR of the neighboring AP and perform a handover operation.

Central Controller 440, which is a main board for controlling overall functions of AT 110, controls a scanning function of AT 110. In more detail, the Central Controller 440 periodically receives neighboring AP information from the serving AP and transmits the received information to Scanning Processing Unit 430.

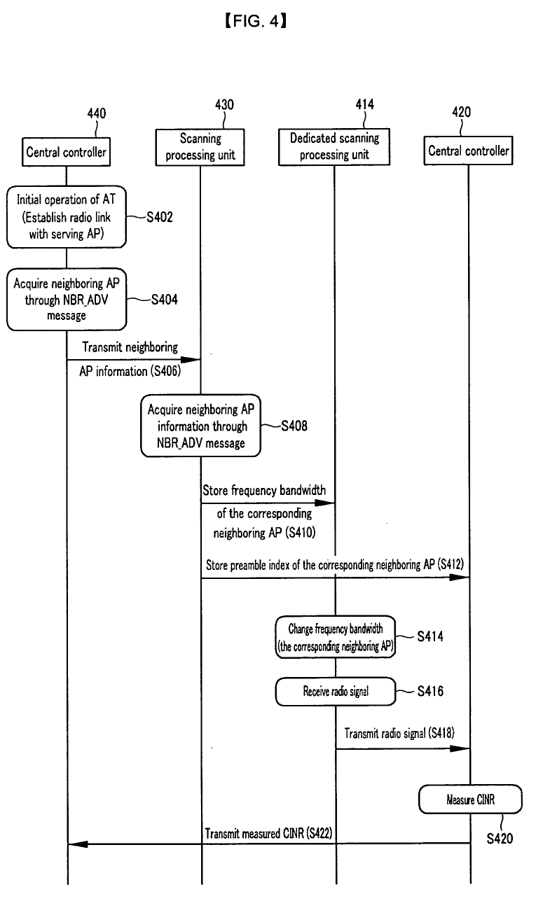

FIG. 4 is a flowchart of the channel scanning apparatus of the portable Internet system according to the exemplary embodiment of the present invention As shown in FIG. 4, as an initial operation, AT 110 is synchronized with the serving AP by a power-on or reset operation such that a radio link is established in step S402. When the radio link is established between AT 110 and the serving AP, the Scanning Processing Unit 430 is changed into a channel scanning operation ready state. In addition, Central Controller 440 receives a neighbor advertisement (NBR-ADV) message that contains the neighboring AP information that has been periodically received from the serving AP. When receiving the NBR-ADV message, Central Controller 440 operates Scanning Processing Unit 430. In addition, Central Controller 440 acquires neighboring AP information necessary for channel scanning from the NBR-ADV message in step S404, and transmits the acquired information to the Scanning Processing Unit 430 in step S406.

When receiving the neighboring AP information from the Central Controller 430, Scanning Processing Unit 430 operates the dedicated Scanning Processing Unit 414 in RF unit 410. Subsequently, Scanning Processing Unit 430 provides the neighboring AP information, that is, a preamble index and frequency bandwidth information of the neighboring AP to dedicated Scanning Processing Unit 414 and in the Modem Processing Unit 420, in steps S410 and S412.

When the neighboring AP information is provided, dedicated Scanning Processing Unit 414 measures a CINR of each of the neighboring APs by switching a frequency bandwidth according to the stored neighboring AP information. In more detail, dedicated Scanning Processing Unit 414 changes the current frequency bandwidth to a frequency bandwidth of one of the neighboring APs and establishes a radio link with the corresponding neighboring AP, in step S414. Then AT 110 is ready to receive a radio signal from the corresponding neighboring AP, and thus AT 110 receives the radio signal from the neighboring AP, in step S416. When receiving the radio signal from the neighboring AP, the dedicated Scanning Processing Unit 414 forwards the received radio signal to the Modem Processing Unit 420, in step S418.

The Modem Processing Unit 420 separates a preamble from the radio signal forwarded from dedicated Scanning Processing Unit 414 and measures the size of the preamble on the basis of the frequency bandwidth information and preamble index information, in step S420. Through the above process, the Modem Processing Unit 420 collects a CINR (i.e., radio channel state information) of the neighboring AP. Modem Processing Unit 420 forwards the collected CINR to Scanning Processing Unit 430, in step S422.

When receiving the CINR from Modem Processing Unit 420, Scanning Processing Unit 430 repeats the above process so as to collect a CINR of another neighboring AP, in steps S408 to S422. By repeating the above process for the number of neighboring APs, CINR of the respective neighboring APs are collected.

The Scanning Processing Unit records the collected CINRs of the neighboring APs, and compares the CINRs of the neighboring APs and a CINR of the current serving AP. When a result of the comparison shows that a difference between the collected CINRs of the neighboring APs and the CINR of the current serving AP is included within a threshold range, the Scanning Processing Unit requests a handover triggering operation from the Central Controller 440. Then, Central Controller 440 starts a handover operation.

Scanning Processing Unit 430 may control a scanning interval according to the collected CINRs of the neighboring APs. That is, Scanning Processing Unit 430 increases the scanning interval to reduce the number of scanning operations when the difference between the CINRs of the neighboring APs and the CINR of the current serving AP exceeds the predetermined threshold range, whereas Scanning Processing Unit 430 decreases the scanning interval to increase the number of scanning operations when the difference is included within the predetermined threshold range.

The above-described invention can be realized not only through a method and an apparatus, but also through a program that can perform functions corresponding to configurations of the present invention or a recording medium storing the program, and a person skilled in the art can easily realize this.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

We claim:

1. A channel scanning apparatus of an Access Terminal (AT) that collects radio channel state information of a neighboring Access Point (AP) in a portable Internet system, the channel scanning apparatus comprising:
a dedicated Scanning Processing Unit for establishing a radio link with the neighboring access point by using neighboring access point information that is required for establishing the radio link and receiving a radio signal;
a Modem Processing Unit for measuring radio channel state information of the neighboring access point from the radio signal received at the dedicated scanning processing unit;
a Scanning Processing Unit for providing the neighboring access point information to the dedicated Scanning Processing Unit and the Modem Processing Unit, and collecting radio channel state information of the neighboring access point, measured by the Modem Processing Unit; and
a Central Controller for controlling operation of the Scanning Processing Unit, periodically receiving the neighboring access point information, and transmitting the neighboring access point information to the Scanning Processing Unit.

2. The channel scanning apparatus of claim 1, further comprising a Radio Frequency (RF) Signal Processing Unit for processing a radio signal transmitted, or received through the radio link established to, or from the serving access point.

3. The channel scanning apparatus of claim 2, wherein the scanning processing unit is placed in an operation ready state when a radio link is established between the access terminal and the serving access point.

4. The channel scanning apparatus of claim 3, wherein the scanning processing unit compares measured radio channel state information of each neighboring access point and radio channel state information of the serving access point, and controls an interval of measuring the radio channel state information.

5. The channel scanning apparatus of claim 3, wherein the modem processing unit measures the radio channel state information from the size of a preamble included in the radio signal received from the neighboring access point.

6. The channel scanning apparatus of claim 1, wherein the radio channel state information of the neighboring access point includes preamble index information of the radio signal received from each neighboring access point, and frequency bandwidth information of each neighboring access point.

7. The channel scanning apparatus of claim 6, wherein the dedicated scanning processing unit changes a current frequency bandwidth to a frequency bandwidth of the neighboring access point to be placed in a ready state ready to receive a radio signal.

8. The channel scanning apparatus of claim 7, wherein the radio channel state information corresponds to a carrier to interference and noise ratio (CINR).

9. A channel scanning method for collecting radio channel state information of neighboring access points in a portable Internet system, the method comprising:
a) providing neighboring access point information required to establish a radio link with the neighboring access point;
b) establishing the radio link with the neighboring access point by using the neighboring access point information, and receiving a radio signal;
c) measuring radio channel state information of the radio signal received from the neighboring access point; and
d) repeating steps a) to c) for each neighboring access point, and collecting radio channel state information for each neighboring access point.

10. The channel scanning method of claim 9, wherein in step b), the establishing of the radio link with the neighboring access point further comprises not disconnecting a radio link with a serving access point.

11. The channel scanning method of claim 10, further comprising:
comparing a difference between the collected radio channel state information of each neighboring access point and radio channel state information of the serving access point to a threshold value,
wherein an interval of measuring radio channel state information of the respective neighboring access points is controlled in accordance with a result of the comparison.

12. The channel scanning method of claim 11, wherein a handover operation is performed in accordance with the result of the comparison.

13. The channel scanning method of claim 9, wherein the neighboring access point information includes preamble index information and frequency bandwidth information of the neighboring access point, and steps a) to c) are repeatedly performed while changing a current frequency bandwidth into a frequency bandwidth of each respective neighboring access point.

14. The channel scanning method of claim 9, wherein in step c), the radio channel station information is measured from the size of a preamble of a radio of each respective neighboring access point, and the radio channel state information corresponds to a carrier to interference and noise ratio (CINR).
